(19) United States
(12) Patent Application Publication
(10) Pub. No.: US 2007/0019614 A1
(43) Pub. Date: Jan. 25, 2007

(54) Method for providing a user interaction dialogue (uid) prior to connection acceptance by the called user

(76) Inventor: Klaus Hoffmann, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/552,895

(22) PCT Filed: Sep. 9, 2003
(86) PCT No.: PCT/EP03/10018

§ 371 Date: Oct. 13, 2005

(51) Int. Cl. H04L 12/66

(52) U.S. Cl. 370/352

(57) ABSTRACT

The invention relates to a method for the provision of a user interactive dialogue UID prior to connection acceptance service for telecommunication terminals in a communication network, wherein a media gateway controller forms a service switching point SSP. Parameters and signaling information necessary for controlling the UID prior to connection acceptance service are transmitted by conversion to the session initiation protocol SIP or are transmitted there from in a standard signaling protocol.

### CROSS REFERENCE TO RELATED APPLICATIONS

This application is the US National Stage of International Application No. PCT/EP2003/010018, filed Sep. 9, 2003 and claims the benefit thereof. The International Application claims the benefits of European application No. 03008955.1 EP filed Apr. 16, 2003, both of the applications are incorporated by reference herein in their entirety.

### FIELD OF INVENTION

This invention relates to a telecommunications system, and more particularly, to providing a user interaction service prior to call/connection acceptance by the called user.

### BACKGROUND OF INVENTION

Packet oriented voice networks, also known as Voice over Packet (VoP) networks, are increasingly replacing or supplementing conventional circuit-switched voice networks (PSTNs=Public Switched Telephone Networks). At the same time, hitherto separate dedicated networks for data transmission and voice transmission are merging to form a single network, frequently referred to as a convergent network or Next Generation Network (NGN).

So-called Media Gateways (MGs) connected to the customer premises equipment on the one hand and to the rest of the network on the other are used as network access units for users of the packet oriented networks. Media Gateways additionally serve to connect PSTN network sections to the packet oriented networks.

In communications networks of the kind in question a distinction is frequently made between signaling information and bearer information. Signaling information relates, for example, to connection setup, cleardown and other call control processes, the bearer information being transmitted, for example, between two parties via the connection.

Accordingly there exist two at least logically different subnetworks in the communications network: the subnetwork for signaling and the subnetwork for bearer information. If a connection exists in the subnetwork for bearer information, this is frequently called a bearer channel.

The bearer information is routed through the packet oriented network via the abovementioned Media Gateways, whereas the signaling information is analyzed and transported by Media Gateway Controllers. In response to the signaling information, the Media Gateway Controllers (MGCs) control the Media Gateways (MGs), which in turn convert the received control into influencing of the bearer channels.

For communication between MGCs, various signaling protocols are available. These include BICC CS2 (Bearer Independent Call Control Capability Set 2) according to ITU-T Q.1902.X, in conjunction with a separate Service Indicator (SI) for the Message Transfer Part (MTP) and Q.765.5 Bearer Application Transport (BAT). For the event that the Real Time Protocol (RTP) is provided in the packet oriented network, this standard describes options for the provision of known PSTN services in a network arrangement wherein two PSTN network sections are connected by means of a packet oriented network. A network arrangement of this kind is shown by way of example in FIG. 1.

FIG. 1 schematically illustrates how, when the signaling and bearer channel are separate, the information required for establishing a communication connection between two telecommunications terminals 1, 2 is exchanged between the individual network components, a calling party requesting an associated local exchange (LE) 5 to set up a call to a telecommunications terminal 2 of a called party via a telecommunications terminal 1 connected to a first PSTN 3.

This call request causes a connection to be set up via a first and second MGC 6, 7, information being transmitted by means of a corresponding signaling protocol to a first Media Gateway Controller 6. In practice the Common Channel Signaling System 7 (CCS7 or SS7) is frequently employed as the signaling protocol, messages of the ISDN User Part (ISUP) being used specifically for connection setup.

The MGC 6 for its part communicates with the second Media Gateway Controller 7 by means of another signaling protocol, such as BICC CS2. The second MGC 7 therefore receives all the signaling information relating to service features or supplementary services and transmits this information to a PSTN 4 in which the terminal 2 of the called party is disposed. The information is in turn transmitted via a corresponding signaling protocol, in a PSTN again generally CCS7.

In addition to the abovementioned other signaling protocol BICC CS2 for MGC-to-MGC communication, the standards RFC 3261 (SIP=Session Initiation Protocol) and RFC 3204 (ISUP MIME Type) allowing tunnel transport of ISUP messages in SIP messages have been developed by the IETF. Such SIP messages for MGC-to-MGC communication are also known as SIP-T messages.

There is also RFC 2976 (INFO method) which provides for the transport of ISUP messages which cannot be mapped onto SIP.

It has been found disadvantageous that with current implementations the service “User Interactive Dialog” (UID) prior to call/connection by the called party (also known as “advance UID”) is not possible.

### SUMMARY OF INVENTION

An object of the invention is therefore to specify a method enabling the “UID prior to call/connection acceptance” service to be provided in a multi-protocol environment of a communications network.

This object is achieved by means of an inventive method for providing a “User Interactive Dialog (UID) prior to call/connection acceptance” service for telecommunications terminals in a communications network having a control element such as a Media Gateway Controller or an Application Server, whereby signaling messages and parameters required for controlling the “UID prior to call/connection acceptance” service are transmitted subject to conversion into the Session Initiation Protocol SIP or from same into a standard signaling protocol.

In respect of the User Interactive Dialog, the control element then constitutes a Service Switching Point SSP.

An obvious advantage of the invention is that it enables SIP parties having direct access to an MGC as Service Control Point (SCP) to use the UID service even without prior acceptance of the call/connection by the called party (i.e. without answer).

In addition, the invention advantageously enables the UID service without prior acceptance of the call/connection by the called party to be used even for PSTN users who are connected via SIP to an MGC as Service Control Point (SCP) by means of a Media Gateway.

The particular advantage of this is that it is possible, for example, to provide services without call charging taking place, which would not be possible in this form after acceptance of the call/connection (i.e. after answer).

Services which generally have to be negotiated at the time of call/connection acceptance at the latest, such as User-to-User Services 2 and 3, can, with the aid of the invention, still be used even after a UID has been conducted.

Further advantageous embodiments of the invention are set forth in the dependent claims.

The following table shows a typical conversion of ISUP or BICC messages and parameters into SIP and/or SDP messages and vice versa:

TABLE 1

| ISUP/BICC | SIP |
|---|---|
| IAM | INVITE |
| UID capability: through connect | with SDP attribute: sendrecv |
| possible, Q.1601 | (send and receive), RFC 3264: |
| | offeranswer, or no corresponding |
| | attribute (default) |
| ACM, CPG | Provisional Response 183 |
| UID action indicator: | with SDP attribute: sendrecv |
| through connect in both directions | |

The following table shows a typical conversion of INAP messages and parameters into SIP and/or SDP messages and vice versa:

TABLE 2

| INAP | SIP |
|---|---|
| ConnectToResources | Provisional Response 183 |
| serviceInteractionIndicatorsTwo: | with SDP attribute: sendrecv |
| through connect indicator = | (send and receive), RFC 3264: |
| required | offeranswer, if INVITE was previously |
| | received with SDP attribute: sendrecv |

### BRIEF DESCRIPTION OF THE DRAWINGS

The invention will now be described in greater detail with reference to an exemplary embodiment in conjunction with the accompanying drawings, in which:

FIG. 1 shows a network arrangement in which two PSTN network sections are connected by means of a packet oriented network, and

FIG. 2 shows a network arrangement in which a control element is a Service Switching Point.

### DETAILED DESCRIPTION OF INVENTION

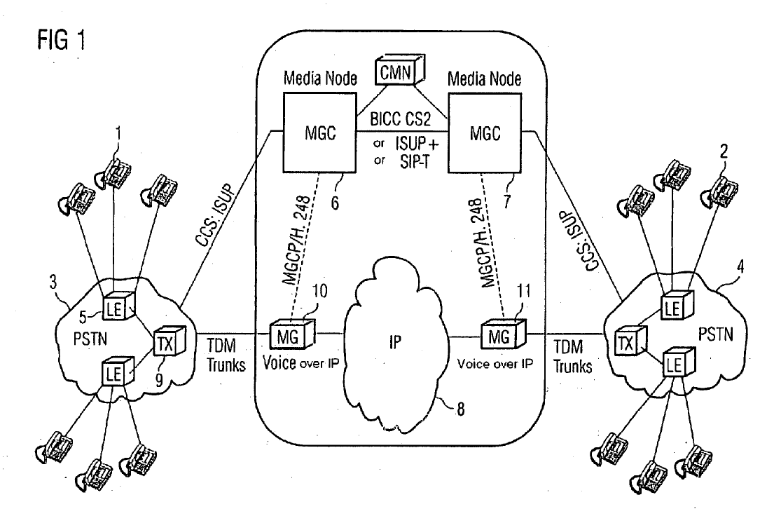

As explained above, FIG. 1 shows a network arrangement whereby two PSTN network sections 3, 4 are connected by means of a packet oriented network 8, the call control information being routed via Media Gateway Controllers 6, 7, the bearer information, on the other hand, via Media Gateways 10, 11. Provided that service control remains in the PSTN, no service control function needs to be performed by the MGCs 6, 7.

The service control of an IN call with UID is explained in ITU-T Q.1601 “Interworking ISUP INAP”, where a UID capability indicator is defined. This indicates whether an origin or calling terminal permits the transporting of bearer data in the forward direction before the call has been accepted in the destination or called terminal (answer). An IN service controlled by a Service Control Point SCP and wishing to transport bearer data from the latter in the forward direction will then instruct the Service Switching Point SSP, for example, in an INAP message “ConnectToResources” with the serviceInteractionIndicatorsTwo using the “through connect indicator” set to “required”, to request advance through connection with the aid of “through connect in both directions” using the ISUP backward message ACM (Address Complete) or CPG (Call Progress). After the party in the origin has used and terminated the UID service, the call can now be passed on to a new destination (the actual called party). For further services such as Follow On or Charging, the SSP can still remain in the connection.

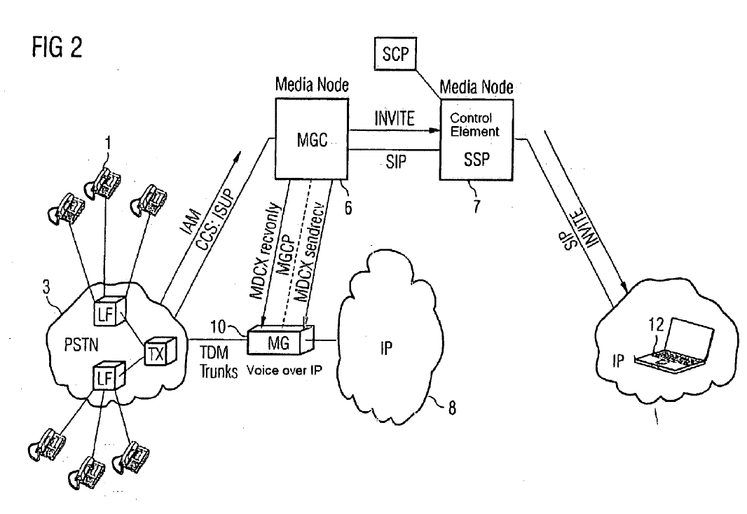

FIG. 2 shows a network arrangement in which a control element is simultaneously a Service Switching Point SSP and is connected to a Service Control Point SCP. In addition, the control element 7 is connected by SIP to other network components such as an SIP terminal 12 or the MGC 6.

Instead of a connection to the SIP terminal 12 there can also exist, from the control element 7, a connection by means of ISDN to an ISDN terminal or a connection by means of BICC, ISUP or SIP to another control element—not shown.

In the network arrangement in FIG. 2, the described Q. 1601 sequences between MGC 6 and control element 7 are signaled by means of SIP messages. For the “User Interactive Dialog prior to call/connection acceptance” service, the information content to be transported for the ISUP and INAP messages and parameters provided for the service can be mapped, for example, in accordance with Tables 1 and 2, onto the Session Initiation Protocol SIP and, if necessary, onto the Session Description Protocol SDP.

On completion of the User Interactive Dialog between the party at the origin and a corresponding UID element, in the example in FIG. 2 the call is forwarded to the SIP terminal, indicated by the INVITE message of control element 7 in the direction of the SIP terminal 12. Generally an SIP Proxy—not shown for the sake of clarity—is involved in the connection between control element 7 and SIP terminal 12.

Other alternative conversions of the service signaling for “User Interactive Dialog UID prior to call/connection acceptance” to the Session Initiation Protocol SIP include the introduction of new explicit identifiers in SIP and/or SDP, e.g. in the form of separate messages, protocol elements or parameters.

The invention can also be used when conversion of ISUP messages and parameters into SIP/SDP messages and parameters does not take place immediately, but other protocols first pick up in the information content of the ISUP messages and parameters before conversion to SIP/SDP takes place—not shown. Such an intermediate protocol, for example, on the path between PSTN and SCP, can be e.g. BICC.

An example of a UID for which the invention can be used will now be briefly explained. A party selects a specific telephone number and is connected to an IN exchange (IN=Intelligent Network). By means of a process executed there, the party is requested to enter a PIN (PIN=Personal Identification Number), and could then be requested to enter another directory number to which he would like to be connected.

1.-9. (canceled)

10. A method of providing a User Interactive Dialog (UID) service prior to call/connection acceptance for telecommunications terminals in a communications network, comprising:
providing a control element that receives messages from the communications network;
converting a signaling message and parameters required for service control from a standard signaling protocol into a Session Initiation Protocol (SIP) to form a SIP message, the service control controlling the UID prior to call/connection acceptance; and
transmitting the SIP message.

11. The method according to claim 10, wherein the control element includes a Service Switching Point.

12. The method according to claim 11, wherein the control element is a Media Gateway Controller or an Application server.

13. The method according to claim 12, wherein the standard signaling protocol is based on a protocol selected from the group consisting of Bearer Independent Call Control (BICC), Integrated Services Digital Network User Part (ISUP), and ISUP+.

14. The method according to claim 13, wherein the parameters and messages required for service control are mapped into a Session Description Protocol (SDP) part of the SIP message.

15. The method according the claims 14, wherein the parameters and messages required for service control are converted from ISUP or BICC to SIP and/or SDP in accordance with the following table:

| ISUP/BICC | SIP |
|---|---|
| IAM | INVITE |
| UID capability: through connect | with SDP attribute: sendrecv |
| possible | |
| ACM, CPG | Provisional Response 183 |
| UID action indicator: | with SDP attribute: sendrecv |
| through connect in both directions | |

16. The method according to claim 14, wherein the parameters and messages required for service control are converted from an Intelligent Network Application Part (INAP) to SIP and/or SDP in accordance with the following table:

| INAP | SIP |
|---|---|
| ConnectToResources | Provisional Response 183 |
| serviceInteractionIndicatorsTwo: | with SDP attribute: sendrecv |
| through connect indicator = required | |

17. The method according to claim 14, wherein after the UID has been conducted, the call is directed to another addressed destination.

18. A method of providing a User Interactive Dialog (UID) service prior to call/connection acceptance for telecommunications terminals in a communications network, comprising:
providing a control element that receives messages from the communications network;
converting a signaling message and parameters required for service control from a Session Initiation Protocol (SIP)/and or Session Description Protocol (SDP) into a standard signaling protocol message, the service control controlling the UID prior to call/connection acceptance; and
transmitting the standard signaling protocol message.

19. The method according to claim 18, wherein the control element includes a Service Switching Point.

20. The method according to claim 19, wherein the control element is a Media Gateway Controller or an Application server.

21. The method according to claim 20, wherein the standard signaling protocol is based on a protocol selected from the group consisting of Bearer Independent Call Control (BICC), Integrated Services Digital Network User Part (ISUP), and ISUP+.

22. The method according to claim 21, wherein the parameters and messages required for service control are mapped into a Session Description Protocol (SDP) part of the SIP message.

23. The method according the claims 22, wherein the parameters and messages required for service control are converted from SIP and/or SDP to ISUP or BICC in accordance with the following table:

| SIP | ISUP/BICC |
|---|---|
| INVITE | IAM |
| with SDP attribute: sendrecv | UID capability: through connect |
| | possible |
| Provisional Response 183 | ACM, CPG |
| with SDP attribute: sendrecv | UID action indicator: |
| | through connect in both directions |

24. The method according to claim 22, wherein the parameters and messages required for service control are converted from SIP and/or SDP to an Intelligent Network Application Part (INAP) in accordance with the following table:

| SIP | INAP |
|---|---|
| Provisional Response 183 | ConnectToResources |
| with SDP attribute: sendrecv | serviceInteractionIndicatorsTwo: |
| | through connect indicator = required |

25. The method according to claim 22, wherein after the UID has been conducted, the call is directed to another addressed destination.
